(19) United States
(12) Patent Application Publication
(10) Pub. No.: US 2013/0287382 A1
(43) Pub. Date: Oct. 31, 2013

(54) BLUETOOTH SHUTTER CONTROLLER FOR CAMERA

(71) Applicant: ARP DEVICES LTD., Hong Kong (CN)

(72) Inventors: Zhendong Xiao, Hong Kong (CN); Longwei Chen, Hong Kong (CN)

(73) Assignee: ARP DEVICES LTD., Hong Kong (CN)

(21) Appl. No.: 13/742,001

(22) Filed: Jan. 15, 2013

(30) Foreign Application Priority Data
Apr. 26, 2012 (CN) 201210125801.1

(51) Int. Cl. G03B 17/38

(52) U.S. Cl. CPC G03B 17/38
USPC 396/59

(57) ABSTRACT

The present invention discloses a shutter controller for a Bluetooth camera, comprising a receiver and a transmitter, wherein the receiver comprises: a microprocessor chip, a power supply, a Bluetooth wireless receiving apparatus and an antenna that are respectively connected to the microprocessor chip, and a connection part operable to connect to a shutter control circuit of the camera; and the receiver communicates with the transmitter by using a Bluetooth chip. The Bluetooth shutter controller for a camera provided in the present invention is power saving, small in size, compatible with a plurality of types of mobile devices, and is simple to operate.

### CROSS-REFERENCE TO RELATED APPLICATIONS

This non-provisional application claims priority under 35 U.S.C. §119(a) on Patent Application No. 201210125801.1 filed in P.R. China on Apr. 26, 2012, the entire contents of which are hereby incorporated by reference.

### FIELD OF THE INVENTION

The present invention relates to a shutter controller for a camera, and particularly to a Bluetooth wireless shutter controller for a camera.

### BACKGROUND OF THE INVENTION

A wireless shutter control for a camera is typically comprised of a transmitter and a receiver. The receiver is connected to a shutter release socket of the camera. A wireless transmitter may be arranged on a remote controller. The remote controller is provided with buttons. When the corresponding button is pressed, the wireless transmitter transmits a signal. The receiver connected to the camera, after receiving an instruction from the transmitter, transmits a shutter release signal to a camera control system. The camera control system immediately performs focusing and picture pickup upon receiving the signal.

The shutter control may also have a time setting function. By using a user interface on a smart phone, a user can easily set advanced functions of the camera, such as long-time exposure, delayed exposure, time lapse exposure.

The existing shutter controller uses the wireless reception and transmission technology which consumes more power. Typically, its receiver needs to work in high duty cycle in order to receive signal from the transmitter. Therefore a receiver and a transmitter requires two AAA batteries or one CR2 battery to operate. And they are bulky due to the size of the battery.

When the time lapse function is used, the receiver of the conventional shutter controller can work only when the transmitter transmits signals constantly. If a time lapse instruction is a long time exposure instruction, the receiver and the transmitter need to be constantly enabled. If there is any interference, the instruction may be transmitted incorrectly, thereby affecting the photo taking progress. Such design also shortens the battery life and restricts the length of the exposure time.

Some shutter controllers designed based on the infrared reception and transmission principles are also available. Such shutter controller consumes less power, and can be power supplied by only a button battery. However, infrared is subject to a short transmission distance (a maximum of 10 meters) and requires a line of sight transmission path, lacking practicality.

To sum up, the wireless communication chip used on the wireless camera shutter controller in the prior art consumes more power compare with our technology. The size of the batteries have to be large enough to sustain the power. Therefore it makes the existing product bulky.

### SUMMARY OF THE INVENTION

The present invention is directed to overcoming the problem in the prior art, and providing a Bluetooth shutter controller for a camera. The shutter controller adopts the Bluetooth wireless communication technology, saves power, has a small size, and can be compatible with multiple types of mobile devices, facilitating usage.

To achieve the above objective, the present invention provides a Bluetooth shutter controller for a camera, including a receiver and a transmitter, where the receiver includes: a microprocessor chip, which is connected to a power supply, Bluetooth receiver with antenna and the camera shutter release control circuitry; The receiver communicates with the transmitter by using their Bluetooth chip.

The receiving device may be embedded in the camera, or integrally designed on the shutter control circuit of the camera.

The camera shutter release controlling circuitry may be a connection wire, the connection wire being connected to the shutter control circuit of the camera; alternatively, the camera shutter release controlling circuitry may also be a connector connected to the shutter control circuit of the camera.

In a preferred embodiment, the receiver further includes a power buck converter circuit connected to the power supply, and a memory module connected to the microprocessor chip and operable to perform a time lapse operation.

The transmitter according to the present invention may be integrally designed on a remote controller, smart phone, iPad or tablet computer provided with the Bluetooth chip.

Compared with the prior art, the shutter controller for the camera according to the present invention uses low-power consumption Bluetooth 4.0 chip to implement wireless communication, saves power, has a small size, and can be connected to variety of Bluetooth transmitter, smart phone, iPad or tablet.

### BRIEF DESCRIPTION OF THE DRAWINGS

The following describes the present invention in detail with reference to accompanying drawings and preferred embodiments. Among the drawings:

FIG. 1 is a schematic diagram illustrating a shutter controller according to the present invention;

FIG. 2 is a schematic diagram illustrating a circuit according to an embodiment of the present invention; and

FIG. 3 is a schematic diagram illustrating instantaneous power consumption of a Bluetooth chip according to the present invention.

### DETAILED DESCRIPTION OF THE EMBODIMENTS

A shutter controller for a camera provided in the present invention includes a receiver and a transmitter, where the receiver communicates with the transmitter by using low-power consumption Bluetooth 4.0. The working principles of the shutter controller are as follows: The transmitter and the receiver negotiate to define a time interval for communication, and disable the wireless communication line in the interval where no communication is needed, thereby reducing power consumption.

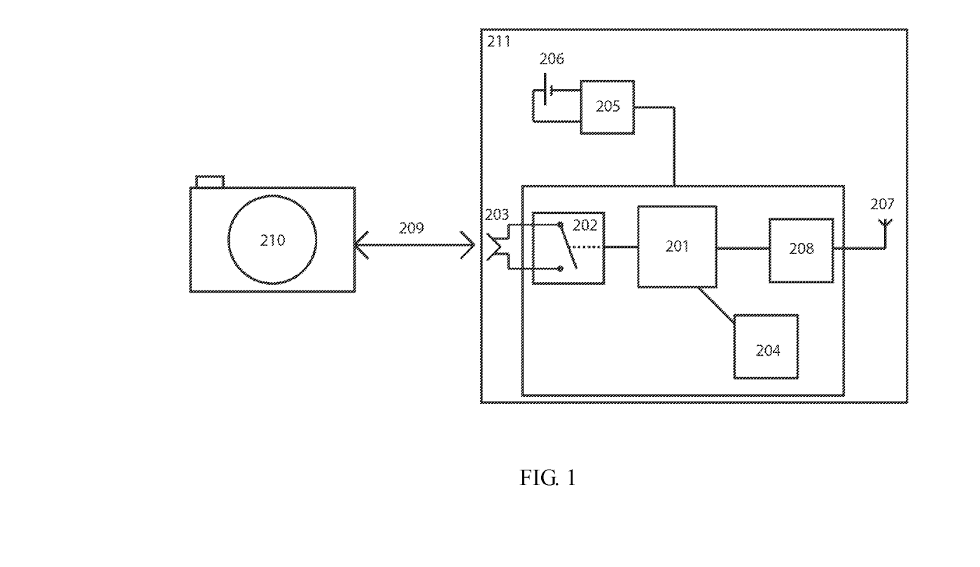

As shown in FIG. 1, a receiver 221 includes a microprocessor chip 201, a power supply 206 and a Bluetooth Low-Energy wireless receiving device 208 that are respectively connected to the microprocessor chip, and a connection part 203 connected to a shutter control circuit of a camera 210; where the receiving device 208 is provided with a chip antenna 207. The transmitter can be installed in a remote controller (not shown in the figure). When the transmitter sends a control instruction to the receiver, the receiver transmits the signal to a shutter release apparatus of the camera for focusing and exposure.

The receiver 211 may be embedded in the camera, or may be integrally designed on the shutter control circuit of the camera or may be arranged as independent hardware. When the receiver 211 is independent hardware, it is connected to the camera by using the connection part 203. The connection part 203 may be a connection wire 209, where the connection wire is connected to the control circuit board of the camera. The connection part 203 may also be a connection plug corresponding to the camera socket.

The receiver may be power supplied by a coin cell 206, where the coin cell may be installed at the bottom of the circuit board of the receiver. The receiver further includes a power buck circuit 205 connected to the power supply in series.

The receiver 211 may further include a memory module 204, operable to store a timed operation instruction sent by the transmitter. The program in the memorization module 204 enables the shutter controller to perform delayed exposure or independently operate for a long period of time. After a delay operation is stored, the receiver does not need to be constantly powered on. To be specific, the receiver may be powered off or set to the minimum duty cycle for further power saving.

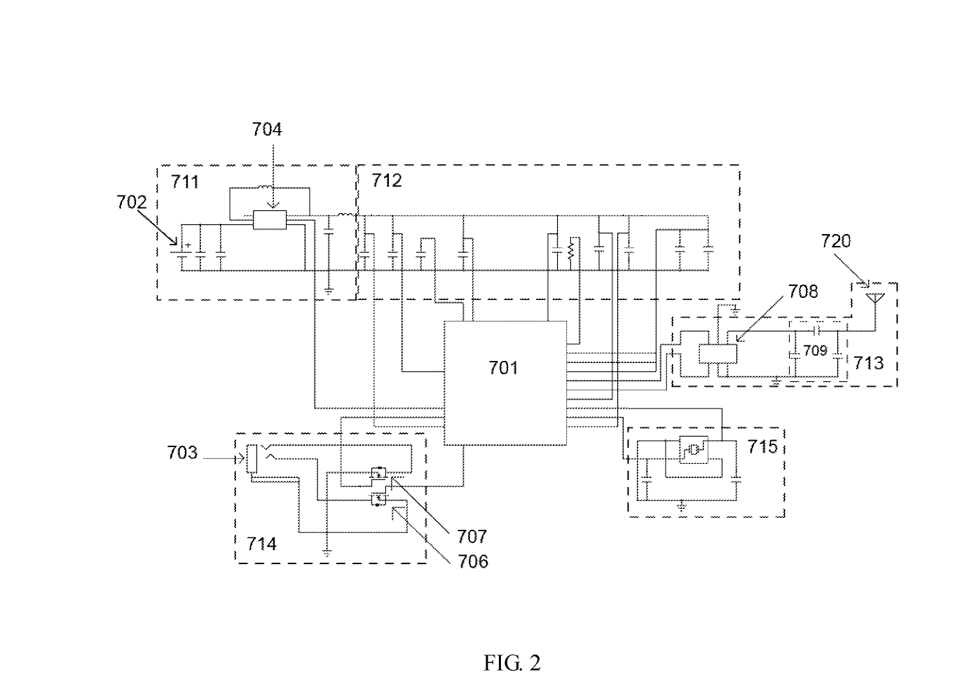

FIG. 2 is a schematic diagram illustrating a circuit according to an embodiment of the present invention. In this embodiment, the receiver 211 includes: a combo chip 701 integrating Bluetooth wireless transmitter, a microprocessor and a memory module; the combo chip is connected to: a power buck circuit 711, a power supply filter circuit 712, a shutter controller circuit 714 of the camera, a radio frequency transceiver circuit 713; and an crystal oscillator circuit 715.

The power buck circuit 711 includes a synchronous buck (DC-DC) chip TPS62730 manufactured by Texas Instruments (TI), that is, 704 in the FIG., and a battery 702 may be a CR2032 battery. The power buck converter circuit 711 can decrease the voltage of the battery 702 to 2.1 V that is required by the entire circuit, for saving power.

The power supply filter circuit 712 is mainly operable to filter noise from the switching mode power supply and provides a reference current for the chip 701.

The shutter control circuit 714 for the camera includes two field effect transistors 706 and 707, and a camera shutter line connector 703. The drains of the field effect transistors 706 and 707 are respectively connected to different pins on the camera shutter line connector 703, and the sources are grounded and connected to one pin of the camera shutter line connector 703, and the gates are connected to an output port of the microprocessor. The field effect transistors 706 and 707 are operable to serve as switches, and are respectively controlled by logic signals output by the chip 701. When the logic is 0, the source and drain of the corresponding field effect transistor are open-circuited; whereas when the logic is 1, the source and drain of the corresponding field effect transistor is short circuited. The field effect transistor 707 is operable to control metering and focusing. When the field effect transistor 707 is short-circuited, the camera considers it as a half-press instruction of the shutter button of the camera, and immediately performs metering and focusing. When the field effect transistor 706 is short-circuited, the camera considers it as a full-press instruction of the shutter button of the camera, and immediately take picture.

The oscillator circuit 715 is mainly operable to provide accurate reference frequencies for Bluetooth signal transmission frequency and microprocessor operations.

The radio frequency transceiver circuit 713 is mainly operable to receive and transmit radio signals, including: a band-pass filter 708 that is comprised of LFB182G45BG2D280 manufactured by MURATA or a plurality of inductor and/or capacitors; an impedance matching circuit 709 that is comprised of one to three chip capacitors and/or coils; and a built-in antenna 720.

According to the present invention, the product using the low-power consumption Bluetooth technology consumes power as less as that a coin cell supplies. Connection interval can be adjusted in the Bluetooth 4.0 communication protocol. The shorter the connection interval, the shorter the communication lag, and however the higher the power consumption. The longer the connection interval, the longer the communication lag, and however the lower the power consumption. A too long delay will increase the time lag between when the shutter release button of the transmitter is pressed and when the camera starts to take picture (hereafter referred to as a shutter lag).

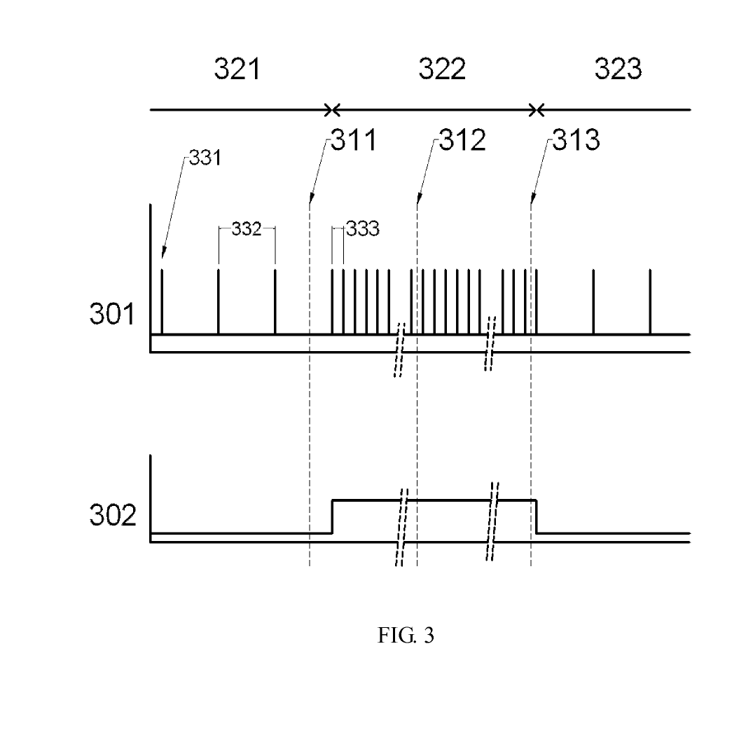

According to the present invention, the connect time interval can be adjusted at different time to shorten the shutter lag and reduce power consumption during stand-by period. As shown in FIG. 3, 301 indicates transient power consumption of the Bluetooth chip on the receiver; and 331 indicates power consumption during data reception and transmission. Each time when data is received or transmitted, the wireless transceiver and the microprocessor on the Bluetooth chip need to be enabled for 2 milliseconds to 20 milliseconds. The current consumption during this time period is generally 15 mA. 332 and 333 indicate time the intervals between each reception and transmission. During this time period, the microprocessor and the Bluetooth chip are in the standby state, and the current consumption thereof is 0.9 μA. Duration of the time interval 332 is longer, which can be as long as 0.5 to 4 seconds; and duration of the time interval 333 is shorter, which can be as short as 0.05 to 0.5 second.

The receiver 211 is in the stand-by state during time interval 321. During this time period, the receiver 211 communicates with the transmitter or broadcasts information of the receiver once per 0.5 to 4 seconds, so that the transmitter can detect the receiver 211 for connection. When time 311 is reached, the shutter transmitter is switched on or an application program of the shutter controller is launched to connect to the receiver 211. In this case, the receiver 211 immediately enters the time interval 332, and is in an active state and communicates with the transmitter once per 0.05 to 0.5 second. This time interval is also the maximum delay of shutter signal transmission.

At time 312, the transmitter transmits a shutter operation signal. Since the receiving party and the transmitting part are both in the active state, the shutter lag is shorter. At time 313, the transmitter turns off or transmits a stand-by instruction. The receiver returns to the stand-by state during the time interval 323 for power saving.

In FIG. 3, 302 indicates average power consumption of the receiver. Within a period of time, the ratio of the time period where the chip 701 is in the high-power consumption state to the length of entire time period (hereafter referred to as duty cycle) is very low, and therefore the average power consumption of the chip 701 is low. The working cycle in the stand-by state is smaller than 0.5%, and the current consumption is typically smaller than 100 μA. The working cycle in the active state is typically 2%, and the current consumption is smaller than 400 μA. A CR2032 battery can accommodate such output power requirements.

With the wide application of the Bluetooth Low-Energy technology in the mobile devices such as mobile phones, the shutter controller with the Bluetooth Low-Energy chip can be operated on a smart phone (for example, iPhone 5), iPad or tablet computer. This does not only greatly reduces the weight of the receiver, but also avoids the trouble of carrying an additional transmitter. In this case, the shutter is easy to carry. In addition, the transmitter of the shutter according to the present invention can be designed integrally on a smart phone, iPad or tablet computer with a Bluetooth chip, and the program on the microprocessor 201 is capable of reading and parsing instructions transmitted by the smart phone.

What is claimed is:

1. A Bluetooth shutter controller for a camera, comprising a receiver and a transmitter, wherein the receiver comprises: a microprocessor chip which is connected to a power supply, a Bluetooth wireless receiver with an antenna, and a camera shutter release control circuitry; and the receiver communicates with the transmitter by using a Bluetooth chip.

2. The Bluetooth shutter controller for a camera according to claim 1, wherein the receiver is embedded in the camera or integrally designed on the shutter control circuit of the camera.

3. The Bluetooth shutter controller for a camera according to claim 1, wherein the connection part is a connection wire, the connection wire being connected to the shutter control circuit of the camera.

4. The Bluetooth shutter controller for a camera according to claim 1, wherein the connection part is a connection interface connected to the shutter control circuit of the camera.

5. The Bluetooth shutter controller for a camera according to claim 1, wherein the receiver further comprises a power buck converter circuit connected to the power supply.

6. The Bluetooth shutter controller for a camera according to claim 1, wherein the receiver further comprises a memory module connected to the microprocessor chip and operable to store a timing operation instruction.

7. The Bluetooth shutter controller for a camera according to claim 1, wherein the power supply uses a coin cell.

8. The Bluetooth shutter controller for a camera according to claim 1, wherein circuit of the receiver comprises: a combo chip formed by the microprocessor chip, a Bluetooth 4.0 wireless receiving device and a memory module; a power buck converter circuit connected in series with the battery, a power supply filter circuit and a radio frequency transceiver circuit that are respectively connected to the chip; and a connection interface connected to the shutter control circuit of the camera.

9. The Bluetooth shutter controller for a camera according to claim 8, further comprising an oscillator circuit connected to the combo chip.

10. The Bluetooth shutter controller for a camera according to claim 1, wherein the transmitter is integrally designed on a remote controller, smart phone, iPad or tablet computer provided with the Bluetooth chip.
